(19) United States
(12) Patent Application Publication
(10) Pub. No.: US 2010/0297878 A1
(43) Pub. Date: Nov. 25, 2010

(54) CABLE CONNECTOR HAVING IMPROVED GOUNDING MEANS

(75) Inventors: PING-SHENG SU, Tu-Cheng (TW); JUN CHEN, Kunshan (CN); FENG-JUN QI, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/783,580

(22) Filed: May 20, 2010

(30) Foreign Application Priority Data
May 20, 2009 (CN) 200920303370.7

(51) Int. Cl. H01R 13/648

(52) U.S. Cl. 439/607.01

(57) ABSTRACT

A cable connector (100) for soldering at a predetermined position with a cable (4) including a number of first wires (41) each having a conductor (412). The cable connector includes an insulative housing (1), a number of contact terminals (2) mounted in the insulative housing, and a pair of shielding shells (3) assembled to the insulative housing. Each contact terminal has a contact portion (21) and a tail portion (22). Each shielding shell is formed with a grounding portion (35) extending toward the tail portion of one of the contact terminals. The grounding portion, the tail portion of one of the contact terminals arrive at the predetermined position and are soldered with the conductor of an associated first wire at the predetermined position.

### BACKGROUND OF THE INVENTION

1. Field of the Invention

The present invention relates to a connector, and more particularly to a cable connector connectable with a cable and having a shielding shell provided with a grounding portion soldered with the cable for grounding.

2. Description of Related Art

U.S. Pat. No. 7,422,488 issued to Wu on Sep. 9, 2008 discloses a cable connector adapted for connecting with a cable having a plurality of conductive wires. The cable connector comprises an insulative housing and a plurality of first and second contacts retained in the insulative housing. The second contacts include a grounding contact and a number of differential signal contacts. The differential signal contact has one end connected with the first contact, and another end soldered with the conductive wire of the cable. The grounding contact has one end soldered with the conductive wire of the cable and another end for grounding. The insulative housing has a tongue portion defining a plurality of first recesses for receiving the differential signal contacts and a second recess for receiving grounding contact.

It is complicated to provide the grounding contact for grounding. Additionally, the second recess would occupy a certain space. It is a hard work to define the second recess beside the four first recesses on the tongue portion which should be designed into a standard dimension.

Hence, a cable connector having an improved grounding means is highly desired.

### SUMMARY OF THE INVENTION

Accordingly, an object of the present invention is to provide a cable connector connectable with a cable and including a shielding shell provided with a grounding portion soldered with the cable for grounding.

In order to achieve the object set forth, a cable connector for soldering at a predetermined position with a cable including a number of first wires each having a conductor. The cable connector includes an insulative housing, a number of contact terminals mounted in the insulative housing, and a pair of shielding shells assembled to the insulative housing. Each contact terminal has a contact portion and a tail portion. Each shielding shell is formed with a grounding portion extending toward the tail portion of one of the contact terminals. The grounding portion, the tail portion of one of the contact terminals arrive at the predetermined position and are soldered with the conductor of an associated first wire at the predetermined position.

The shielding shell has a grounding portion extending therefrom and soldered with the contact terminal and the cable for grounding. It doesn't need to provide any grounding terminals or other extra grounding members. The cable connector has a simple configuration and it is easy to perform grounding.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view showing a cable connector and a cable;

FIG. 2 is a perspective view showing the cable connector and the cable, with a cover of the cable separated from the cable connector;

FIG. 3 is an assembled perspective view showing the cable connector and the cable;

FIG. 4 is a view similar to FIG. 3, taken from another aspect; and

FIG. 5 is a view of the cable connector and the cable, with the first housing and the cover being removed.

### DETAILED DESCRIPTION OF THE PREFERRED EMBODIMENT

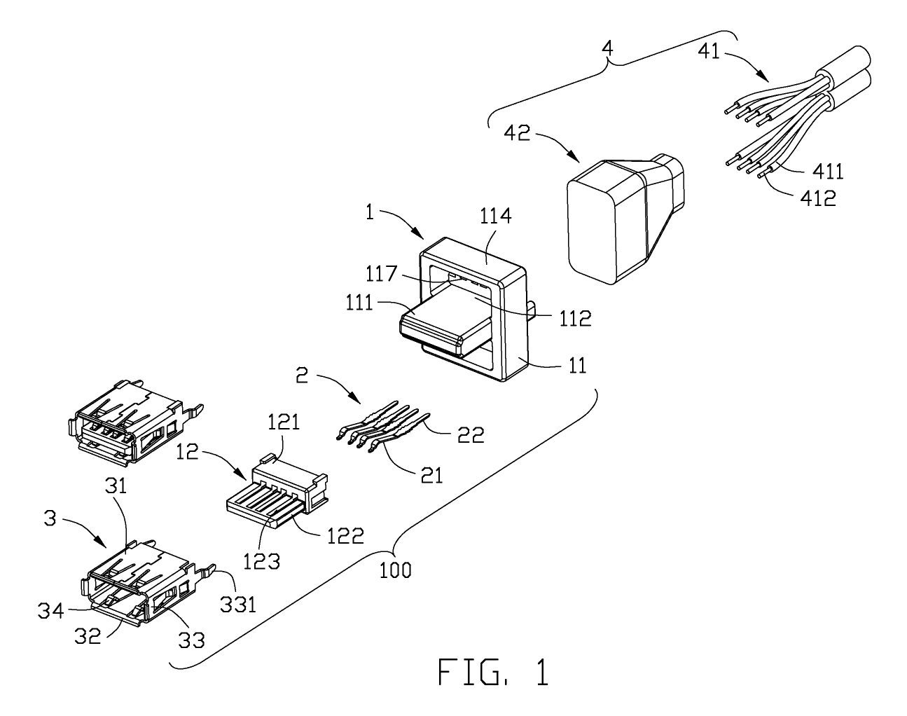

Reference will now be made in detail to the preferred embodiment of the present invention. Referring to FIG. 1, a cable connector 100 is adapted for connecting with a cable 4. The cable connector 100 is a USB (Universal Serial Bus) connector or other types of connector. The cable connector 100 comprises an insulative hosing 1, a plurality of contact terminals 2 inserted in the insulative housing 1 and a pair of shielding shells 3 attached to the insulative housing 1.

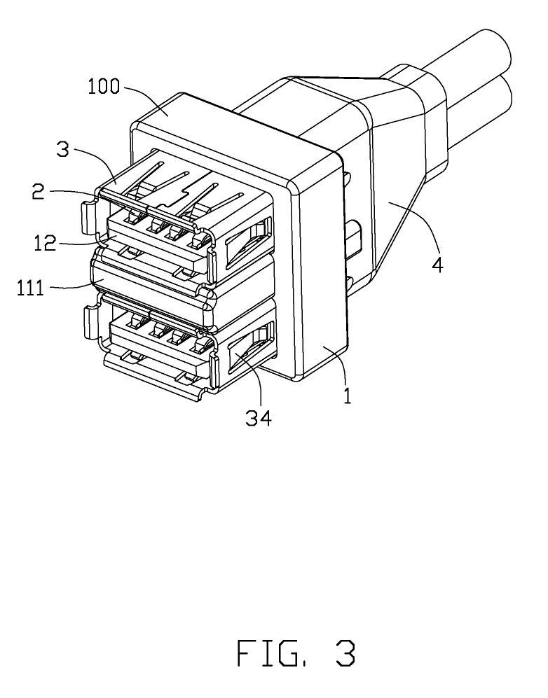

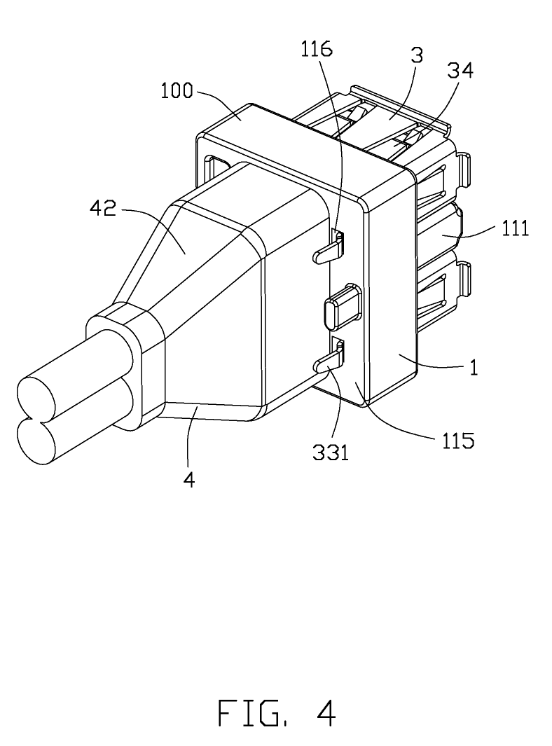

Referring to FIGS. 1-5, the insulative housing 1 comprises a first housing 11 and a pair of second housings 12. The first housing 11 comprises a body portion 114 having a rear wall 115, and a protruding portion 111 protruding beyond the body portion 114. The body portion 114 has a pair of inserting recesses 112 defined at opposite sides of the protruding portion 111. The rear wall 115 of the body portion 114 defines a plurality of first slots 116 and second slots 117 communicating with the inserting recesses 112.

Each second housing 12 comprises a body portion 121 and a tongue portion 122 protruding forwardly from the body portion 121. The second housing 12 defines a plurality of passageways 123.

Each contact terminal 2 comprises a contact portion 21 and a tail portion 22.

Each shielding shell 3 comprises a top wall 31, a bottom wall 32, a pair of side walls 33 and a plurality of resilient beams 34. Each side wall 33 of the shielding shell 3 has a resisting portion 331 extending rearwardly from a rear edge thereof. The bottom wall 32 of the shielding shell 3 is provided with a grounding portion 35.

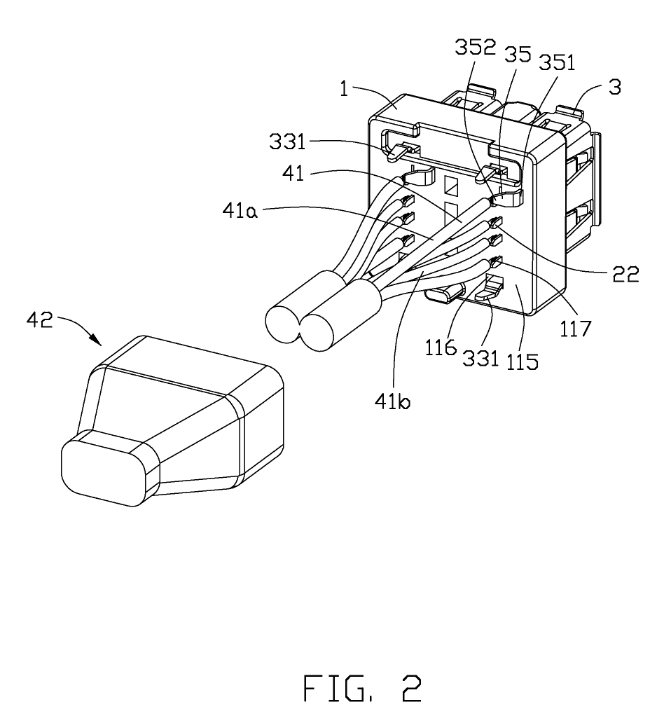

Referring to FIG. 2, the cable 4 includes a plurality of wires 41 categorized with a plurality of first wires 41a and a plurality of second wires 41b, and a cover 42 shrouding the wires 41. Each wire 41 comprises an outer jacket 411 and a conductor 412 partially exposed from the outer jacket 411. The first wire 41a is connected to cathode of power. The second wire 41b is connected to anode of power and signal source.

Referring to FIGS. 1-4, in assembling of the cable connector 100, the plurality of contact terminals 2 are inserted in the passageways 123 of the second housing 12. The pair of second housings 12 are inserted in the pair of inserting recesses 112, with the tail portions 22 of the contact terminals 2 inserting outwardly from the second slots 117. The pair of shielding shells 3 are respectively mounted on the pair of second housings 12, with the resisting portions 331 inserting through the rear wall 115 of the first housing 11. Each shielding shell 3 is formed with a connecting portion 351 extending from a rear edge of the bottom wall 32 and extending through the first slot 116. When the connecting portion 351 is inserted through the first slot 116, the grounding portion 35 has a free end bent from the connecting portion 351 toward the tail portion 22 of the contact terminal 2 to form a bending portion 352. The direction to which the resisting portion 331 faces is perpendicular to the direction to which the grounding portion 35 faces.

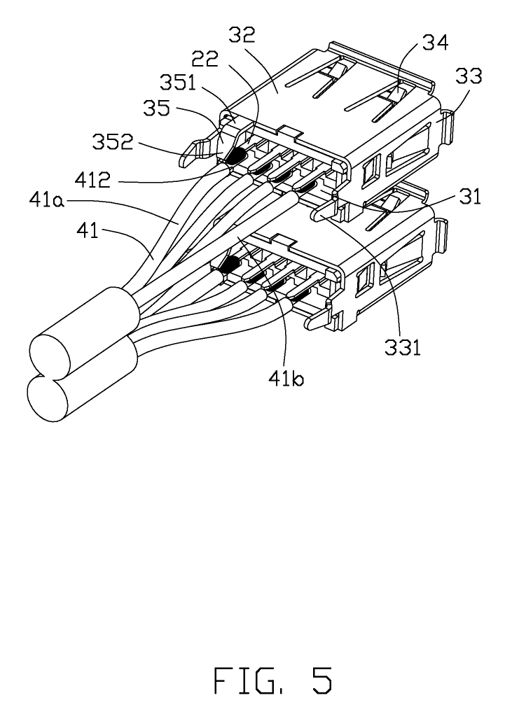

Referring to FIGS. 2 and 5, when the cable 4 is soldered onto the cable connector 100, the conductor 412 of the first wire 41a, the tail portion 22 of the associated contact terminal 2 and the bending portion 352 of the grounding portion 35 arrive at a predetermined position and are soldered as a whole at the predetermined position. The conductor 412 of the second wire 41b and the tail portions 22 of the associated contact terminal 2 are soldered as a whole. The cover 42 is assembled to the insulative housing 1 and enclose the wires 41, with the resisting portions 331 resisting against the cover 42 of the cable 4.

The shielding shell 3 has a grounding portion 35 extending from the rear edge thereof. The tail portion 22 of the contact terminal 2, the conductor 412 of the cable 4 and the grounding portion 35 of the shielding shell 3 are soldered as a whole for transmitting signal and for grounding simultaneously. It doesn't need to provide any extra grounding members to realize grounding easily.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable connector for soldering at a predetermined position with a cable comprising a plurality of first wires each having a conductor, comprising:
an insulative housing;
a plurality of contact terminals mounted in the insulative housing, each contact terminal having a contact portion and a tail portion;
at least one shielding shell assembled to the insulative housing and formed with a grounding portion extending toward the tail portion of one of the contact terminals, said grounding portion and said tail portion of the one contact terminal being soldered together with said conductor of an associated first wire.

2. The cable connector as claimed in claim 1, wherein there are two shielding shells, and there are two grounding portions each formed on one of the shielding shells.

3. The cable connector as claimed in claim 2, wherein said grounding portion comprises a connecting portion extending from a rear edge of the shielding shell and a bending portion bent toward the associated tail portion.

4. The cable connector as claimed in claim 3, wherein said shielding shell comprises a top wall, a bottom wall and a pair of side walls, said connecting portion of the grounding portion connecting with the rear edge of the bottom wall.

5. The cable connector as claimed in claim 4, wherein said side walls of the shielding shell are formed with a pair of resisting portions for resisting against an outer surface of the cable.

6. The cable connector as claimed in claim 5, wherein said grounding portion of the shielding shell faces toward a direction substantially perpendicular to another direction to which the resisting portion faces.

7. The cable connector as claimed in claim 2, wherein said insulative housing comprises a first housing and a pair of second housings inserted in the first housing, said contact terminals being mounted in the first housing, said two shielding shells being respectively attached to the pair of second housings.

8. The cable connector as claimed in claim 7, wherein said first housing comprises a rear wall and a pair of inserting recesses respectively receiving said pair of second housings, said rear wall defining a plurality of slots communicating with said inserting recesses for insertion of said tail portions of the contact terminals and said grounding portions of the shielding shells.

9. The cable connector as claimed in claim 8, wherein said first housing is formed with a protruding portion between the pair of inserting recesses, said pair of second housings being located at opposite sides of the protruding portion.

10. A cable assembly comprising:
a cable connector comprising an insulative housing, a plurality of contact terminals mounted in the insulative housing each having a tail portion, and a shielding shell attached to the insulative housing and formed with a grounding portion; and
a cable connected with the cable connector and comprising a plurality of first wires each having a conductor, said conductor of one of the first wires of the cable, the tail portion of one of the contact terminals and the grounding portion of the shielding shell being soldered together at a predetermined position.

11. The cable assembly as claimed in claim 10, wherein said cable comprising a plurality of second wires each having a conductor, said tail portion of another contact terminal is soldered with said conductor of an associated second wire.

12. The cable assembly as claimed in claim 11, wherein said first wires are connected to cathode of power, and said second wires are partially connected to anode of power and are partially connected to signal source.

13. The cable assembly as claimed in claim 11, wherein said cable has a cover enclosing the first and second wires, said shielding shell is formed with a pair of resisting portions resisting against the cover of the cable, said grounding portion of the shielding shell facing toward a direction substantially perpendicular to another direction to which each resisting portion faces.

14. A cable connector assembly comprising:
a first insulative housing;
a second insulative housing located in front of the first housing and equipped with a mating tongue extending forwardly thereof;
a plurality of contacts including one signal contact thereof and disposed in the second housing with contacting sections exposed upon the mating tongue and soldering tails exposed rearwardly beyond the first insulative housing;
a metallic shell defining a rectangular frame structure surrounding the second insulative housing;
the metallic shell including at least one grounding leg inwardly bent toward and around the soldering tail of said one signal ground contact; and
a plurality of wires soldered to the corresponding soldering tails, respectively, wherein
the wire soldered to the tail section of the one signal ground contact is further soldered to the grounding leg of the shell.

15. The cable connector assembly as claimed in claim 14, wherein said first insulative housing and said second insulative housing are discrete from each other while being assembled together.

16. The cable connector assembly as claimed in claim 15, wherein said first insulative housing and said second insulative housing are fastened together via said shell.

17. The cable connector assembly as claimed in claim 15, wherein said shell includes a plurality of resisting portions extending through and beyond the first insulative housing.

18. The cable connector assembly as claimed in claim 17, wherein said wires and the corresponding soldering tails are enclosed in the cover, and the resisting portions are located outside of the cover and abut against the cover.

19. The cable connector assembly as claimed in claim 14, wherein a third insulative housing with correspond contacts and shell, is assembled to the first insulative housing;

20. The cable connector assembly as claimed in claim 19, wherein said first insulative housing defines a protruding portion separating said second insulative housing and the third insulative housing.
